(19) United States
(12) Patent Application Publication
(10) Pub. No.: US 2006/0009052 A1
(43) Pub. Date: Jan. 12, 2006

(54) Relay, in particular for a plug installation, and method for the production thereof

(76) Inventor: Ralf Hoffmann, Berlin (DE)

Correspondence Address: BARLEY SNYDER, LLC, 1000 WESTLAKES DRIVE, SUITE 275, BERWYN, PA, 19312, US

(21) Appl. No.: 11/176,837

(22) Filed: Jul. 7, 2005

(30) Foreign Application Priority Data
Jul. 7, 2004 (DE) 102004032737.8

(51) Int. Cl. H01R 12/00

(52) U.S. Cl. 439/76.2

(57) ABSTRACT

A coil housing for a relay and a method of making the same, the coil housing comprises a first housing member and a second housing member. The first housing member includes a first flange with a first tubular half extending therefrom. The second housing includes a second flange with a second tubular half extending therefrom. The second tubular half engages with the first tubular half to form a coil receiving tube connecting the first and second housing members. Connectors formed of a punched sheet metal are molded in at least one of the first and second housing members.

### FIELD OF THE INVENTION

The invention relates to a relay and, more particularly, to a coil housing for a relay comprising first and second housing members with connectors injection-molded therein and a method for embedding the connectors in the first and second housing members.

### BACKGROUND OF THE INVENTION

Relays, such as miniaturized relays that weigh only a few grams, are used in automotive applications and are suitable for high switching currents of up to approximately 30 A. Although there are many types of relays, a distinction is often drawn between soldered relays and plug-in relays. The soldered relays can either have connectors in the form of soldering lugs located substantially parallel to a lower side of the housing or connection pins extending substantially perpendicularly from a lower side of the relay. The soldering lugs are suitable for use in surface mount technology (SMT), and the connection pins are suitable for use in conventional through-mount technology where the connection pins are inserted into apertures in a printed circuit board and soldered on an opposing side thereof. Plug-in relays, on the other hand, have flat, optionally relatively wide, connectors, which are commonly known as FASTON connectors. These connectors extend substantially perpendicular from a base side of the relay and can be rapidly inserted into sockets with little installation effort.

Additionally, a distinction is drawn between relays that have the connectors injection molded therein and relays that have the connectors installed by plug installation. In the plug installation process, the connectors are fitted into a coil housing after is has been injection-molded. Because the connectors are often oversized, the connectors tightly fit into the coil housing when inserted therein. During insertion, particles may therefore abrade as a result of the parts overlapping, which may lead to contact errors during operation of the relay. In the injection installation process, the connectors, which may be formed from punched sheet metal, are embedded in the coil housing. The connectors are either individually inserted into an open injection mold, which is laborious, or are inserted into an injection mold connected in a strip, which requires high sheet metal consumption. The connectors are conventionally inserted into the injection mold parallel to a parting plane thereof. The desired arrangement of the connectors in the coil housing is therefore complex because it involves a plurality of parting planes and/or alternating parting planes in order to provide “rear” mold planes.

To alleviate these problems, DE 197 47 166 C1 proposes a modified, efficient injection-molding process. In this process, connection pins are embedded in a coil housing. The connection pins are arranged in two or more parallel offset planes in a region of flanges of the coil housing. This process requires only one parting plane, which extends transversely through flanges and a coil receiving tube of the relay. When the mold is closed, the connection pins are fed in the form of drawn wires through channels extending perpendicularly to the parting plane in the mold half into the mold. The connecting pins are then embedded in position in a region of the flanges, so that only one parting plane is required as a result of the feed process.

This injection-molding process, however, may not be used with relatively wide connectors, such as FASTON connectors. These wide connectors are usually too rigid to be drawn as a wire from a supply roll. Additionally, these connectors can not be connected in a strip or easily introduced as individual parts into the closed mold through a mold half in the feed process. A wire-feed process is also problematic, because unlike the connection pins, these connectors require a chamfer in two planes at a plug-in side for facilitating insertion into a socket, which would have to be laboriously applied to the finished part after injection molding. Further, if profiled wire is used for the connectors, contacts will have to be welded to the connectors after injection-molding. Heating of the plastic material in a region of the embedding of the connectors cannot be avoided during this procedure. As a result, glass fibers may become detached from the plastic material, which may lead to contact disturbances.

### SUMMARY OF THE INVENTION

It is therefore an object of the invention to provide a relay comprising connectors, such as FASTON connectors, and a simple, cost-effective injection-molding process for embedding the connectors in the relay.

This and other objects are achieved by a coil housing for a relay comprising a first housing member and a second housing member. The first housing member includes a first flange with a first tubular half extending therefrom. The second housing includes a second flange with a second tubular half extending therefrom. The second tubular half engages with the first tubular half to form a coil receiving tube connecting the first and second housing members. Connectors formed of a punched sheet metal are molded in at least one of the first and second housing members.

This and other objects are further achieved by a method of making a coil housing for a relay. The method comprises the steps of providing at least two leadframes with punched connectors. The leadframes are arranged so that the connectors of one of the lead frames are positioned in-between the connectors of the other lead frame. First housing members and second housing members are then injection-molded with the leadframes so that the connectors are partially embedded therein.

### BRIEF DESCRIPTION OF THE DRAWINGS

FIG. 1 is a perspective view of a relay according to the invention;

FIG. 2 is a schematic illustration of an installation sequence in the production of the relay shown in FIG. 1;

FIG. 3 is an exploded view of a coil housing;

FIG. 4 is a lateral view of the coil housing shown in FIG. 3;

FIG. 4A a lateral view of another embodiment of the coil housing;

FIG. 5 is a perspective view of another embodiment of the relay;

FIG. 6 is a perspective view of still another embodiment of the relay;

FIG. 7 is a lateral view of an arrangement of first and second housing members and connectors during injection-molding; and

FIG. 8 is a perspective oblique view of the arrangement shown in FIG. 7.

### DETAILED DESCRIPTION OF THE INVENTION

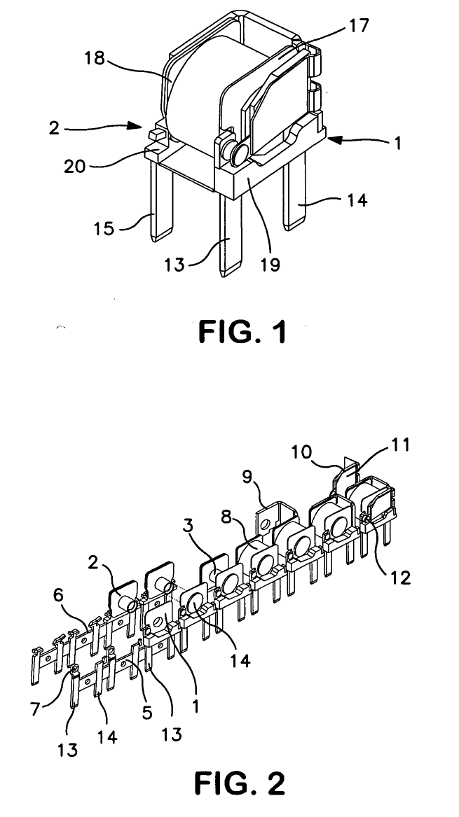

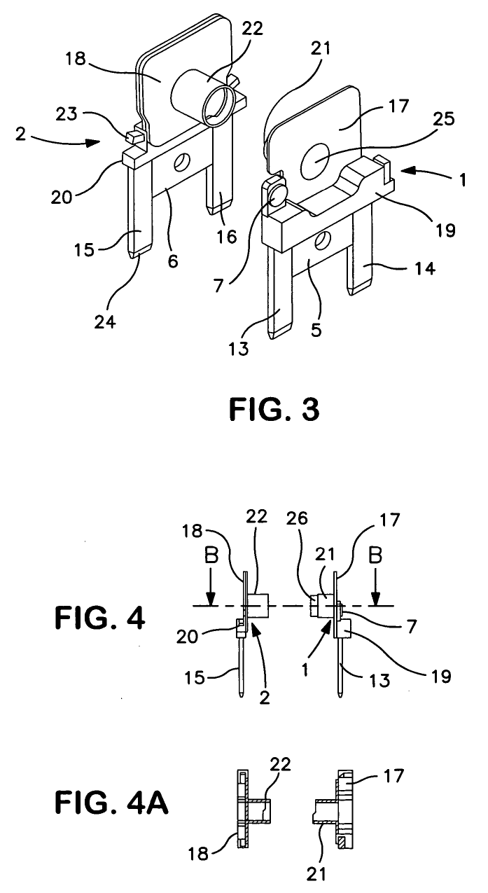

FIG. 1 shows by way of example a relay (some housing elements have been omitted). The relay has as a support member a coil housing comprising a first housing member 1 joined with a second housing member 2. The first housing member 1 has a first flange 17, and the second housing member 2 has a second flange 18. As shown in FIG. 3, a first tube half 21 extends from the first flange 17, and a second tube half 22 extends from the second flange 18. The first and second tube halves 21, 22 are permanently joined to form a coil receiving tube 3, as shown in FIG. 2. In order to join the first and second tube halves 21, 22, a free end of the first tube half 21 may be formed with a projection that is at least partially received in the second tube half 22, as shown in FIG. 4. Alternatively, an outside surface or an inside surface of either the first tube half 21 or the second tube half 22 may be geometrically configured to positionally secure and/or prevent twisting of the first and second housing members 1, 2, as shown in FIG. 4A. The first and second tube halves 21, 22 do not have to be symmetrically formed. A winding 8 is attached to the coil receiving tube 3, as shown in FIG. 2.

As shown in FIG. 3, the first and second housing members 1, 2 each have extensions 19, 20, respectively. The configuration of the extensions 19, 20 is not limited to the embodiment shown herein. Connectors, 13, 14, 15, 16 such as FASTON connectors, are injection-molded, into a lower region of the first and second flanges 17, 18. The connectors 13, 14 15, 16 extend substantially parallel to the first and second flanges 17, 18. The connectors 13, 14 15, 16 may be, for example, embedded into the extensions 19, 20. The connectors 13, 14, 15, 16 may be made, for example, from punched sheet metal. In the illustrated embodiment, the connector 13 is provided with a fixed contact 7, and the connector 15 is provided with a lug 23. Chamfers 24, which may be formed in two planes to facilitate insertion of the connectors 13, 14, 15, 16 into corresponding sockets (not shown), may be formed at plug-in-side ends of the connectors 13, 14, 15, 16.

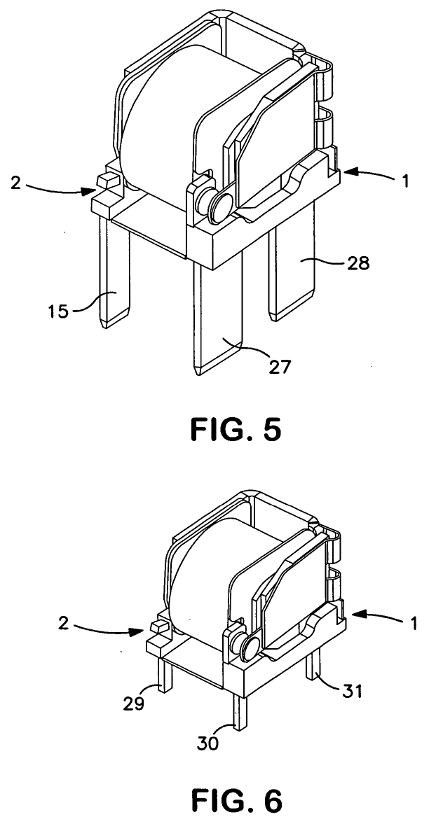

FIG. 5 shows a slightly modified embodiment of the relay. In FIG. 5, connectors 27, 28 are load connectors and are configured with wider connectors than the connectors 15, 16, which are coil connectors. The typical FASTON widths of the connectors 15, 16, 27, 28 are 2.8 millimeters, 4.8 millimeters, and 6.3 millimeters, however these widths may be varied. The connectors 27, 28 may be embedded or inserted into the coil housing. FIG. 6 shows an additional modification of the relay. In FIG. 6, connectors 29, 30, 31 are constructed as connection pins that are suitable for soldering to a printed circuit board (not shown). The connectors, 29, 30, 31 may be embedded or inserted into the first and second housing members 1, 2.

As shown in FIG. 2, the coil housing holds a magnet system and a contact system. The first housing member 1 includes a core receiving through-hole 25 corresponding with the first tube half 21, which receives a core 4, as shown in FIGS. 2 and 3. A yoke 9, which is typically L-shaped, is fixed to the core 4. A spring module comprising an armature 10, a spring contact 11, and a movable contact 12, is joined and electrically connected to the yoke 9.

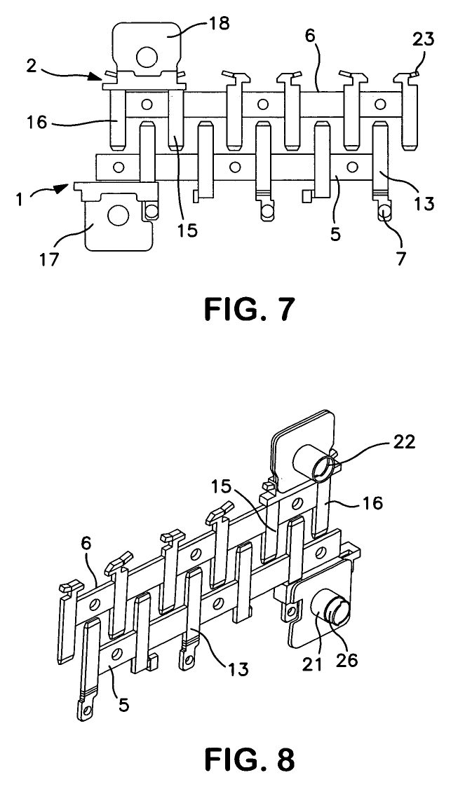

The assembly of the relay will now be described in greater detail. As shown in FIGS. 7 and 8, partially punched connectors 13, 14, 15, 16 are arranged on a strip or leadframe 5, 6, respectively, in pairs. The connectors 13, 14, 15, 16 of the first and second housing members 1, 2 are arranged next to each other in parallel on the strip so that the connectors 13, 14, 15, 16 opposing each other engage with one another in a finger-like manner. Each of the leadframes 5, 6 is then injection-molded with either the first housing member 1 or the second housing member 2 so that the connectors 13, 14, 15, 16 are partially embedded therein. The leadframes 5, 6 may be bent for this purpose, if necessary, and may be provided with the fixed contact 7. Alternatively, the connectors 13, 14, 15, 16 may be provided as individual inserts that are injection-molded with the first and second housing members 1, 2. FIG. 3 shows the first and second housing members 1, 2, illustrated with the leadframes 5, 6, respectively.

In the illustrated configuration, the first and second housing members 1, 2 are injection-molded in a common die, so the illustrated arrangement comprising parallel opposing first and second housing members 1, 2 or connectors 13, 14, 15, 16 reflects the installation sequence shown schematically in FIG. 2 up to the moment of joining of the first and second housing members 1, 2. Alternatively, the first and second housing members 1, 2 may be injection-molded in separate dies.

As shown in the installation sequence in FIG. 2, after removal of the leadframes 5, 6, the core 4 is inserted into the core receiving aperture 25 in the first housing member 1. The core 4 helps to fix and join the first housing member 1 to the second housing member 2. The first tube half 21 and the second tube half 22 are then joined to form the coil receiving tube 3 and connect the first housing member 1 to the second housing member 2. Alternatively, the core 4 may be inserted into the core receiving aperture 25 after the first and second housing members 1, 2 have been joined.

The winding 8 is then wound onto the coil receiving tube 3. The lug 23 facilitates the winding-on of the winding 8. The yoke 9, which is typically L-shaped, is then inserted or welded onto the core 4. A spring module that comprises the armature 10, the spring contact 11, and the movable contact 12, is then electrically connected to the yoke 9 and fastened thereto by, for example, riveting or laser welding.

The relay according to the invention is produced in two halves that each have a parting plane. Each half includes, for example, two of the connectors 13, 14, 15, 16, which may be load connectors or coil connectors. However, it is also possible, for example, to produce an additional fixed contact for the load connectors substantially in the plane of the first flange 17 or even to produce a slightly offset contact plane, for example using an alternating parting plane for the first housing member 1. With a slightly higher outlay in the unravelling inside the relay, the allocation of the connectors 13, 14, 15, 16 may also be altered. It is also possible, for example, to embed only some of the connectors 13, 14, 15, 16, which may easily be injected in almost any configuration as a result of having only one parting plane, and to insert the remaining connectors 13, 14, 15, 16 during the installation process. In this embodiment, it is advantageous if the embedded connectors are provided as coil connectors and the connectors inserted in the installation process are provided as load connectors of the relay.

An advantage of the relay according to the invention is that during production, an additional transverse slide in the injection mold is not required for a core receiving through-hole 25 located in the parting direction of the two-part injection mold. Additionally, because the first and second housing members 1, 2 may be injection-molded using separate injection-molding dies or a common die, material consumption of the punched metal sheet is reduced. For example, in the arrangement shown in FIGS. 7 and 8, the connectors 13, 14, 15, 16 are placed in common strips in the injection mold for optimal utilization of the punched sheet metal material. As a result of the mutual engagement of the connectors 13, 14, 15, 16, part of the material, which is otherwise consumed as waste in the gaps, is utilized for the respectively opposing connector. The plane formed by the common strips and the first and second flanges 17, 18 corresponds approximately to the parting plane of the common injection-molding die so that the amount of punched material wasted to be kept low, thereby substantially assisting cost-effective production.

The invention is accordingly based on the idea of addressing the injection-molding process problems caused by the shape of the coil housing and the connectors arranged therein, not by the provision of elaborate, varying or complex individual parting planes in the injection mold, but rather by the division (“intersection” approximately in the center between the parting planes, which otherwise extend in the first and second flange planes) of the actual coil housing to be injected into two separate halves. The individual first and second housing members 1, 2, which are initially unconnected, may thus in each case easily be produced in injection molds having only one parting plane and then be joined in the region of a core receiving through-hole 25 to form a complete coil housing.

In an advantageous embodiment, the injected connectors 13, 14, 15, 16 are constructed as FASTON connectors, which are made of a punched flat material and are suitable for plug installation. The connectors 27, 28 may also exhibit a varying material thickness, in particular a varying width. The use of the punched flat material also allows the fastening of contact rivets or weld contacts prior to injection molding or insertion, thus eliminating the risk of glass fibers becoming detached from the plastic material.

I/We claim:

1. A coil housing for a relay, comprising:
a first housing member including a first flange with a first tubular half extending therefrom;
a second housing including a second flange with a second tubular half extending therefrom, the second tubular half being engageable with the first tubular half to form a coil receiving tube connecting the first and second housing members; and
connectors molded in at least one of the first and second housing members, the connectors being formed of a punched sheet metal.

2. The coil housing of claim 1, wherein the connectors are molded in the first and second flanges.

3. The coil housing of claim 1, further comprising other connectors plugged into at least one of the first and second housing members.

4. The coil housing of claim 1, wherein the first tube half includes a projection that is received in the second tube half.

5. The coil housing of claim 1, wherein the connectors have a width of about 2.8 millimeters.

6. The coil housing of claim 1, wherein the connectors have a width of about 4.8 millimeters.

7. The coil housing of claim 1, wherein the connectors have a width of about 6.3 millimeters.

8. The coil housing of claim 1, wherein the connectors extend substantially parallel to the first and second flanges.

9. The coil housing of claim 1, wherein at least one of the connectors includes a fixed contact.

10. The coil housing of claim 1, wherein at least one of the connectors includes a lug.

11. The coil housing of claim 1, wherein the connectors include chamfers on an edge thereof.

12. The coil housing of claim 1, wherein the first tube half includes a core receiving through-hole.

13. The coil housing of claim 12, further comprising a core arranged in the core receiving through-hole, and a yoke including a spring module being fixed to the core.

14. A method of making a coil housing for a relay, comprising the steps of:
providing at least two leadframes with punched connectors;
arranging the leadframes so that the connectors of one of the lead frames are positioned in-between the connectors of the other lead frame; and
injection-molding first housing members and second housing members with the leadframes so that the connectors are partially embedded therein.

15. The method of claim 14, wherein the first and second housing members are injection-molded in a common die.

16. The method of claim 14, wherein fixed contacts are provided on the connectors of at least one of the leadframes before injection-molding.

17. The method of claim 14, wherein lugs are provided on the connectors of at least one of the leadframes before injection-molding.

18. The method of claim 14, further comprising the step of bending the leadframes.

19. The method of claim 14, further comprising the step of inserting the connectors into a two-piece die parallel to a parting plane of the die prior to injection-molding.

20. The method of claim 14, wherein the connectors are positioned in the same plane.
